(19) United States
(12) Patent Application Publication
(10) Pub. No.: US 2025/0126568 A1
(43) Pub. Date: Apr. 17, 2025

(54) PERFORMING ACTIONS AT A USER EQUIPMENT (UE) DEPENDING ON A MOBILITY MODE ASSOCIATED WITH THE UE

(71) Applicant: QUALCOMM Incorporated, San Diego, CA (US)

(72) Inventors: Wei-Jei SONG, San Diego, CA (US); Rajeev PAL, San Diego, CA (US); Tom CHIN, San Diego, CA (US); Yongle WU, San Diego, CA (US); Xuqiang ZHANG, Beijing (CN); Jose Alfredo RUVALCABA, Poway, CA (US)

(21) Appl. No.: 18/684,493

(22) PCT Filed: Oct. 29, 2021
(86) PCT No.: PCT/CN2021/127320

§ 371 Date: Feb. 16, 2024

(51) Int. Cl. H04W 52/02; H04W 36/36; H04W 84/00

(52) U.S. Cl. CPC H04W 52/028; H04W 36/36; H04W 84/005

(57) ABSTRACT

Various aspects of the present disclosure generally relate to wireless communication. In some aspects, a user equipment (UE) may receive, via a user interface of the UE, an indication of a mobility mode associated with the UE, wherein the mobility mode indicates an environment associated with the UE. The UE may perform an action based at least in part on the mobility mode associated with the UE. Numerous other aspects are described.

### FIELD OF THE DISCLOSURE

Aspects of the present disclosure generally relate to wireless communication and to techniques and apparatuses for performing actions at a user equipment (UE) depending on a mobility mode associated with the UE.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory; and one or more processors, coupled to the memory, configured to: receive, via a user interface of the UE, an indication of a mobility mode associated with the UE, wherein the mobility mode indicates an environment associated with the UE; and perform an action based at least in part on the mobility mode associated with the UE.

In some implementations, a method of wireless communication performed by a UE includes receiving, via a user interface of the UE, an indication of a mobility mode associated with the UE, wherein the mobility mode indicates an environment associated with the UE; and performing an action based at least in part on the mobility mode associated with the UE.

In some implementations, a non-transitory computer-readable medium storing a set of instructions for wireless communication includes one or more instructions that, when executed by one or more processors of a UE, cause the UE to: receive, via a user interface of the UE, an indication of a mobility mode associated with the UE, wherein the mobility mode indicates an environment associated with the UE; and perform an action based at least in part on the mobility mode associated with the UE.

In some implementations, an apparatus for wireless communication includes means for receiving, via a user interface of the apparatus, an indication of a mobility mode associated with the apparatus, wherein the mobility mode indicates an environment associated with the apparatus; and means for performing an action based at least in part on the mobility mode associated with the apparatus.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIGS. 3-4 are diagrams illustrating examples associated with performing actions at a UE depending on a mobility mode associated with the UE, in accordance with the present disclosure.

FIG. 5 is a diagram illustrating an example process associated with performing actions at a UE depending on a mobility mode associated with the UE, in accordance with the present disclosure.

FIG. 6 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

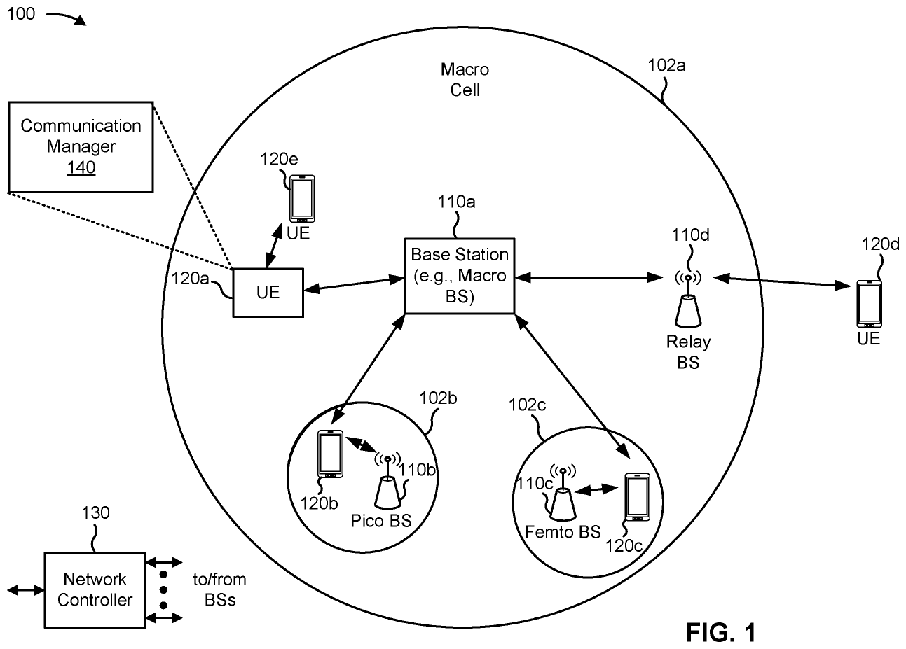

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, via a user interface of the UE, an indication of a mobility mode associated with the UE, wherein the mobility mode indicates an environment associated with the UE; and perform an action based at least in part on the mobility mode associated with the UE. Additionally, or alternatively, the communication manager 140 may perform one or more other operations described herein.

As indicated above, FIG. 1 is provided as an example. Other examples may differ from what is described with regard to FIG. 1.

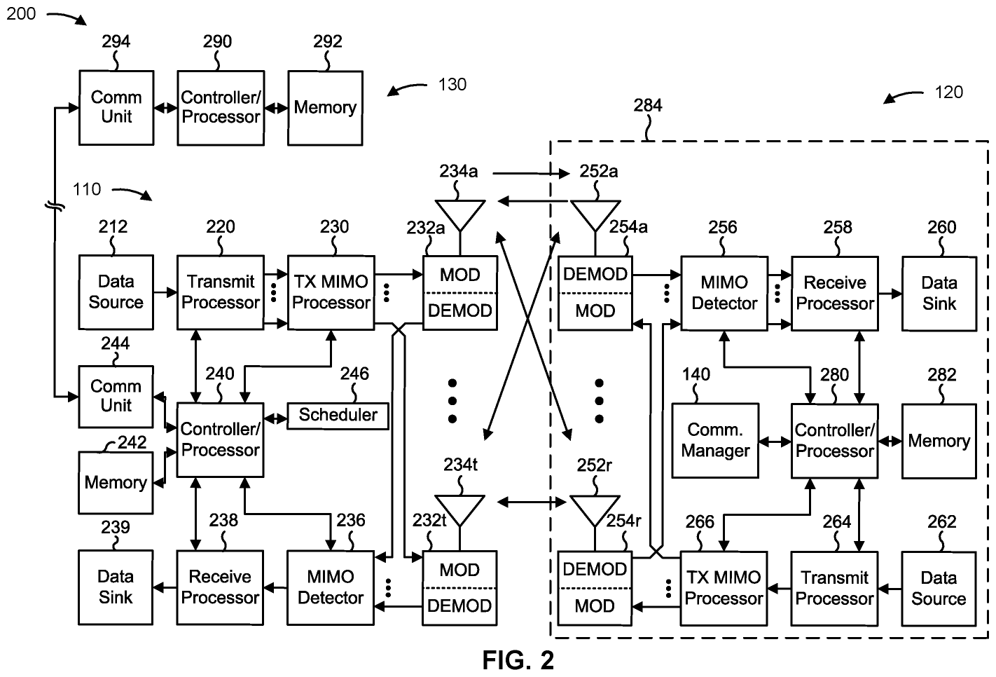

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120 The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

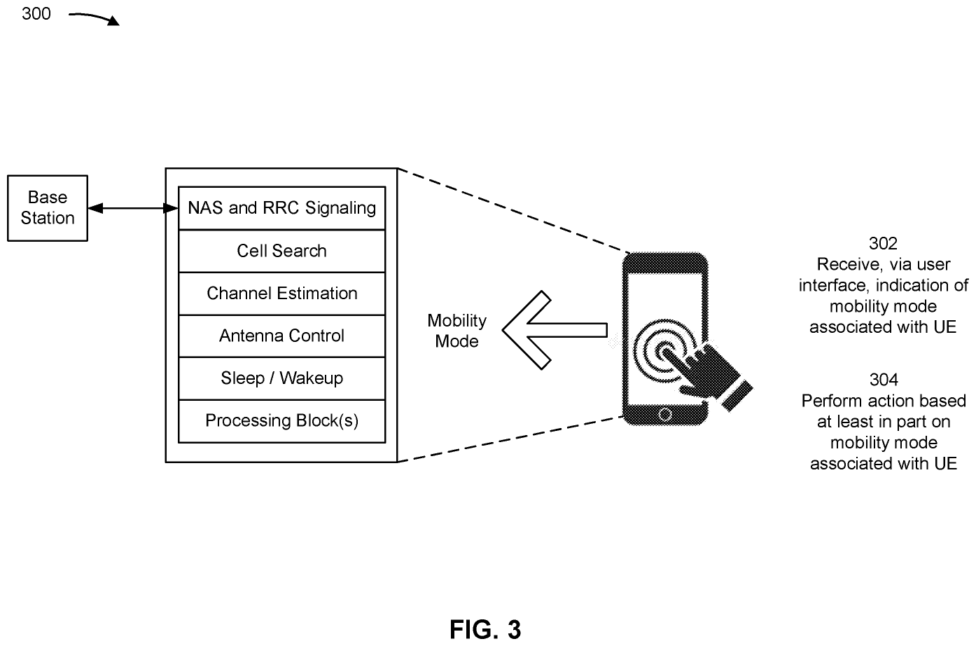

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-6).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-6).

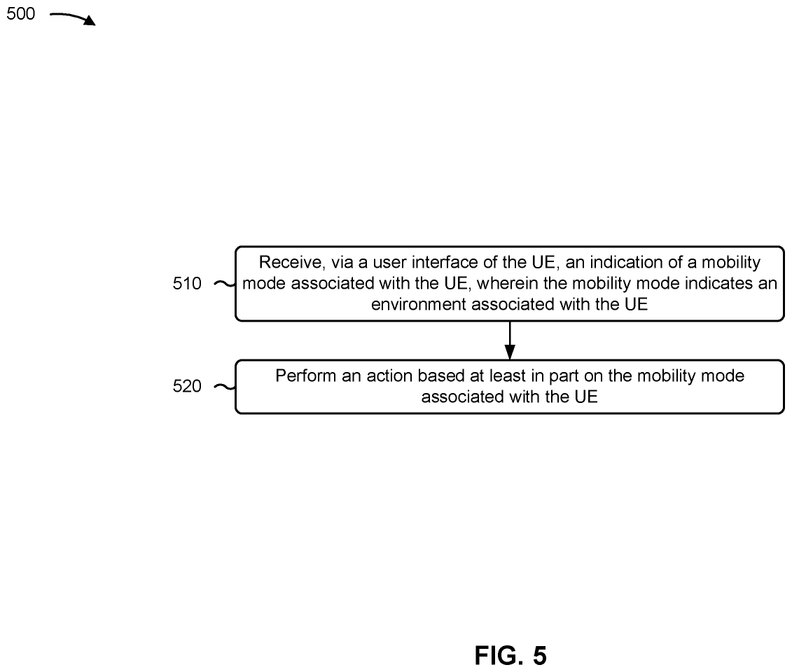

The controller/processor 240 of the base station 110, the controller/processor 280 of the UE 120, and/or any other component(s) of FIG. 2 may perform one or more techniques associated with performing actions at a UE depending on a mobility mode associated with the UE, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, via a user interface of the UE, an indication of a mobility mode associated with the UE, wherein the mobility mode indicates an environment associated with the UE; and/or means for performing an action based at least in part on the mobility mode associated with the UE. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

A base station may determine an environment associated with a UE based at least in part on signaling between the base station and the UE and/or measurements indicated to the base station by the UE. The base station may transmit, to the UE, a configuration associated with the environment. The configuration may indicate one or more parameters that are tailored to the environment. The UE may employ the configuration to improve power savings, a performance, and/or a user experience In other words, the base station may determine the environment and transmit the configuration associated with the environment to the UE, and the UE may subsequently employ the configuration received from the base station.

As an example, the base station may determine that the UE is associated with a high speed environment, based at least in part on signaling between the base station and the UE. The high speed environment may indicate that the UE is onboard a high speed train or another vehicle that is traveling at a relatively high speed. The base station may transmit, to the UE, a high speed configuration based at least in part on the determination that the UE is associated with the high speed environment. The high speed configuration may indicate a high speed measurement flag. When the high speed measurement flag is present in the high speed configuration and the UE supports a measurement enhancement, the UE may apply enhanced intra-NR and inter-RAT Evolved-UMTS Terrestrial Radio Access Network (E-UTRAN) radio resource management (RRM) requirements to support a high speed up to 500 km/hour. The UE may be configured to follow a set of rules based at least in part on the indication of the high speed measurement flag received from the network. The UE may follow the set of rules for an idle mode or a connected mode. Further, the high speed configuration may indicate a high speed demodulation flag. When the high speed demodulation flag is present in the high speed configuration, the UE may apply an enhanced demodulation processing for a high speed train (HST) single frequency network (SFN) joint transmission scheme with a velocity up to 500 km/hour. The UE may be unable to determine that the UE is associated with the high speed environment without signaling from the base station.

In some cases, the base station may be unable to detect the environment associated with the UE, and the base station may not transmit the configuration associated with the environment. In some cases, the base station may not have a capability of detecting the environment associated with the UE. For example, an ability to detect the environment associated with the UE may be an LTE feature, but the base station may be deployed in a network that only employs NR and does not employ LTE. In this case, the base station may be unable to detect the environment associated with the UE. In some cases, the base station may face challenges in detecting the environment associated with the UE due to characteristics of an operating band. For example, band 78 may be associated with a relatively high frequency and a relatively high Doppler shift, thereby making detection more difficult. In some cases, the base station may transmit the configuration associated with the environment, but the UE may not receive the configuration. For example, the UE may be in a tunnel, on a bridge, a train station platform with high signal interference, or at another location that prevents the UE from receiving the configuration. In this case, the UE does not employ the configuration, which may negatively impact the power savings, the performance, and/or the user experience associated with the UE.

In various aspects of techniques and apparatuses described herein, a UE may receive, via a user interface of the UE, an indication of a mobility mode associated with the UE. The mobility mode may indicate an environment associated with the UE. A user associated with the UE may indicate, via the user interface, the mobility mode associated with the UE. The user interface may provide an interactive touch interface and/or a voice command interface. The mobility mode may correspond to a high speed train. The mobility mode may correspond to a passenger vehicle on a freeway, in a city, in a rural setting, or on a body of water (e.g., the UE may be on a boat or a cruise ship). The mobility mode may correspond to a power conservation mode. The UE may perform an action based at least in part on the mobility mode associated with the UE. The UE, when performing the action, may disable or enable one or more features of the UE based at least in part on the mobility mode associated with the UE. The UE, when performing the action, may override a network control based at least in part on the mobility mode associated with the UE. In other words, the UE may not rely on receiving, from a base station, a configuration associated with the environment of the UE. Rather, the UE may determine the environment via the user interface and not using other means such as artificial intelligence, since the user associated with the UE may be best suited to provide input on the environment associated with the UE. As a result, the UE may be able to better deploy certain configurations that improve the power savings, the performance, and the user experience.

FIG. 3 is a diagram illustrating an example 300 associated with performing actions at a UE depending on a mobility mode associated with the UE, in accordance with the present disclosure.

As shown by reference number 302, the UE may receive (e.g., using controller/processor 280), via a user interface of the UE, an indication of a mobility mode associated with the UE. The mobility mode may indicate an environment associated with the UE (e.g., high speed train, passenger vehicle, or power conservation). In some aspects, the user interface may provide a touch interface. For example, the user interface may display a plurality of possible mobility modes, and a selection of one of the plurality of possible mobility modes may be received from a user of the UE via the touch interface. In some aspects, the user interface may provide a voice command interface. For example, the user of the UE may speak the mobility mode associated with the UE, and the voice command interface may detect the speech from the user. The UE may determine the mobility mode associated with the UE based at least in part on the user interface, which may include the touch interface, the voice command interface, or another suitable interface that is able to receive the indication of the mobility mode associated with the UE. The UE may use the user interface to remove a dependency on the base station for determining the mobility mode.

In some aspects, the mobility mode indicating the environment associated with the UE may be a high speed train mode. The high speed train mode may be associated with the UE traveling on a high speed train. In some aspects, the mobility mode indicating the environment associated with the UE may be a subway mode. The subway mode may be associated with the UE traveling on a subway. In some aspects, the mobility mode indicating the environment associated with the UE may be a passenger vehicle mode. The passenger vehicle mode may include a freeway mode associated with the UE traveling on a freeway. The passenger vehicle mode may include a city mode associated with the UE traveling in a city. The passenger vehicle mode may include a rural mode associated with the UE traveling in a rural area. The passenger vehicle mode may include a water body mode associated with the UE traveling on a body of water.

In some aspects, the mobility mode indicating the environment associated with the UE may be a vehicle operation mode. The vehicle operation mode may indicate whether the UE is being operated by an occupant of a vehicle. One or more capabilities (e.g., text, browser) of the UE may be locked based at least in part on the vehicle operation mode. The UE may be switched to a hands-free voice command mode for distraction avoidance. In some aspects, the mobility mode indicating the environment associated with the UE may be a power conservation mode. The power conservation mode may be associated with limited services for the UE to reduce a power consumption of the UE. The limited services may involve limiting the UE to use only certain functionalities, such as navigation or voice capability, in order to reduce the power consumption of the UE.

In some aspects, the UE may determine the mobility mode for the UE based at least in part on signal measurements. The mobility mode determined from the signal measurements may be an inferred mobility mode. The UE may provide, via the user interface, a recommendation to switch to the mobility mode. The UE may receive, via the user interface, a selection of the mobility mode. Alternatively, the user interface may receive an indication that the recommended mobility mode is not associated with the UE.

As shown by reference number 304, the UE may perform (e.g., using controller/processor 280) an action based at least in part on the mobility mode associated with the UE. The action may be associated with non-access stratum (NAS) and radio resource control (RRC) signaling with the base station, a cell search operation and cell measurements, a channel estimation, an antenna control, a sleep or wakeup operation, or a processing block activation/deactivation. The UE may perform the action based at least in part on the mobility mode, which may result in increased power savings and/or improved performance for the UE. The UE may perform the action autonomously without an instruction from the base station, based at least in part on the mobility mode associated with the UE. The UE may perform the action without the dependency on the base station.

In some aspects, when performing the action, the UE may disable or enable one or more features of the UE based at least in part on the mobility mode associated with the UE. The one or more features may be features that are typically controlled by the base station. However, since the base station may sometimes not accurately detect the environment associated with the UE, the UE may determine to disable or enable the one or more features without instructions from the base station. In some aspects, when performing the action, the UE may override a network control based at least in part on the mobility mode associated with the UE.

As an example, the base station may detect that the UE is associated with a high speed environment, and the base station may transmit to the UE a configuration associated with the high speed environment. In certain situations, such as when the UE is on a high speed train that is currently stopped at a train station, the UE may unnecessarily waste power by employing the configuration associated with the high speed environment. In these cases, the UE may receive, via the user interface, an instruction to override the configuration associated with the high speed environment. The UE may not employ the configuration associated with the high speed environment unless another instruction is received via the user interface. In this case, the user associated with the UE may wish to avoid running the configuration associated with the high speed environment when the high speed train is not current moving, in order to save battery power at the UE. The UE may perform an action irrespective of the configuration associated with the high speed environment (e.g., a high speed measurement flag) received from the base station. In other words, the UE may not need to depend on receiving the configuration associated with the high speed environment from the base station. The configuration associated with the high speed environment may be a high speed configuration, which may include a high speed measurement flag and/or a high speed demodulation flag.

As another example, when a battery of the UE is critically low, transmitting a UE assistance information message from the UE to the base station to indicate a low battery power may unnecessarily further consume the battery of the UE. The UE may receive, from the user interface, an indication to turn off certain features of the UE to save battery power. As yet another example, the base station may automatically activate certain features for the UE such as dual connectivity and/or carrier aggregation, even when such features do not benefit the UE in certain network conditions. The UE may receive, from the user interface, an indication to turn off these features to improve a performance of the UE. In other words, the UE may deactivate these features even though the features were activated by the base station.

In some aspects, when performing the action, the UE may perform a cell search operation and cell measurements based at least in part on the mobility mode associated with the UE. The cell search operation may be based at least in part on a property of a cell associated with the mobility mode.

As an example, the UE may determine that the high speed train mode is associated with the UE. In a high speed train scenario, cells may be elongated in a rectangular shape, as opposed to a circular shape commonly associated with cells. Further, in the high speed train scenario, a high speed train may be moving in a given direction, such that the high speed train, at any given point in time, is moving towards one cell and is moving away from another cell. In this case, the UE may not need to perform the cell search operation and cell measurements for a plurality of cells. Rather, the UE may only perform the cell search operation and the cell measurements for a limited quantity of cells (e.g., an upcoming cell), which may reduce an amount of signaling and computation at the UE. The UE may be able to perform the cell search operation and cell measurements in this manner based at least in part on the determination that the mobility mode associated with the UE is the high speed train mode. A high speed train network and cell topology and coverage may be unique with the rectangularly shaped cells, so the UE may utilize this information to perform the cell search operation and cell measurements using less power.

As another example, when the mobility mode associated with the UE indicates that the UE is in a certain setting, the UE may increase or decrease a periodicity of the cell search operation and cell measurements. For example, when the mobility mode indicates that the UE is in a city, the UE may perform the cell search operation and cell measurements relatively often. As another example, when the mobility mode indicates that the UE is in the rural area or the body of water, the UE may perform the cell search operation and cell measurements less often to save power. In this case, the UE may avoid wasting battery power by searching for cells that are not available due to the environment associated with the UE.

In some aspects, when performing the action, the UE may perform a channel estimation based at least in part on the mobility mode associated with the UE. The UE may perform the channel estimation using different parameters that are based at least in part on the mobility mode associated with the UE. For example, the UE may perform the channel estimation using a first set of parameters for a first mobility mode, whereas the UE may perform the channel estimation using a second set of parameters for a second mobility mode.

In some aspects, when performing the action, the UE may perform an antenna control based at least in part on the mobility mode associated with the UE. The antenna control may involve an adaptive receive diversity (ARD) process or other antenna-related processes. The UE may perform the antenna control using different parameters that are based at least in part on the mobility mode associated with the UE. For example, the UE may perform the antenna control using a first set of parameters for a first mobility mode, whereas the UE may perform the antenna control using a second set of parameters for a second mobility mode.

In some aspects, when performing the action, the UE may perform a sleep/wakeup operation based at least in part on the mobility mode associated with the UE. The UE may perform the sleep/wakeup operation using different parameters that are based at least in part on the mobility mode associated with the UE. For example, the UE may perform the sleep/wakeup operation using a first set of parameters for a first mobility mode, whereas the UE may perform the sleep/wakeup operation using a second set of parameters for a second mobility mode. For example, in the rural area, the UE may sleep for a longer duration of time as compared to when the UE is in the city.

In some aspects, when performing the action, the UE may activate or deactivate a processing block based at least in part on the mobility mode associated with the UE. The processing block may be associated with a heavy duty processing for relatively large amounts of data. Depending on the mobility mode associated with the UE, the UE may activate or deactivate the processing block to save power and/or improve a performance of the UE.

In some aspects, when performing the action, the UE may perform a handover based at least in part on the mobility mode associated with the UE. For example, the UE may perform the handover differently depending on whether the UE is associated with the city, the freeway, or the rural area. In some aspects, when performing the action, the UE may apply safety features based at least in part on the mobility mode associated with the UE. For example, depending on the vehicle operation mode indicating whether the UE is being operated by the occupant of the vehicle, the UE may apply the safety features accordingly.

As indicated above, FIG. 3 is provided as an example. Other examples may differ from what is described with regard to FIG. 3.

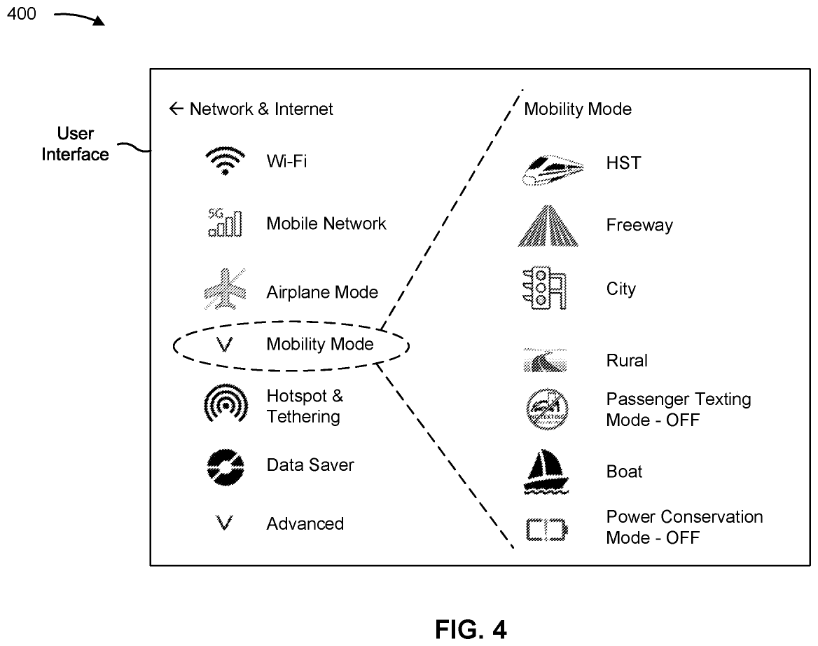

FIG. 4 is a diagram illustrating an example 400 associated with performing actions at a UE depending on a mobility mode associated with the UE, in accordance with the present disclosure.

As shown in FIG. 4, a user interface associated with the UE may include an option to view a menu associated with a “Network and Internet”. The menu associated with the “Network and Internet” may include options associated with WiFi, a mobile network, an airplane mode, a mobility mode, hot spot and tethering, and saving data. When the mobility mode option is selected, a user associated with the UE may select one of a plurality of possible mobility modes. The plurality of possible mobility modes may be associated with a high speed train, a freeway, a city, a rural area, a passenger texting mode, a boat, a power conservation mode, or other suitable modes that relate to an environment of the UE.

As indicated above, FIG. 4 is provided as an example. Other examples may differ from what is described with regard to FIG. 4.

FIG. 5 is a diagram illustrating an example process 500 performed, for example, by a UE, in accordance with the present disclosure. Example process 500 is an example where the UE (e.g., UE 120) performs operations associated with performing actions at a UE depending on a mobility mode associated with the UE.

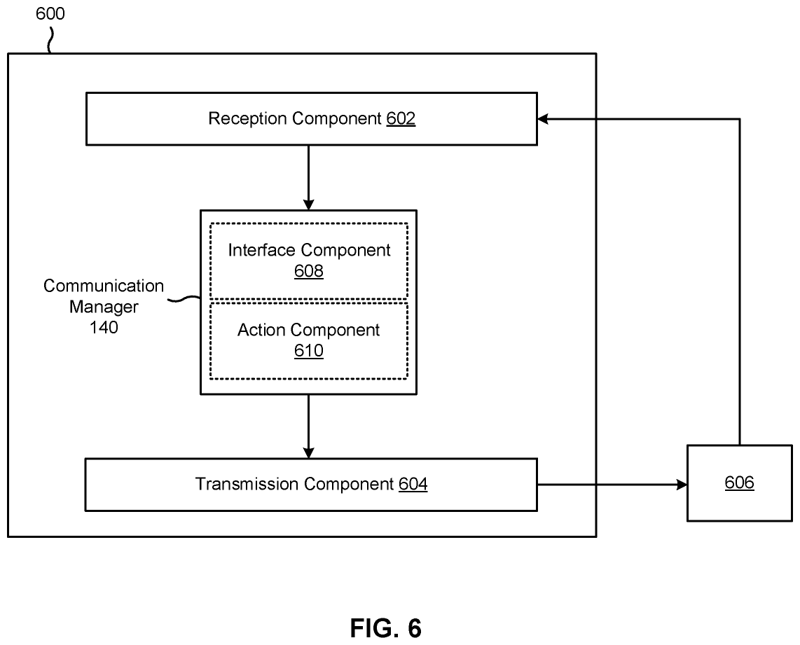

As shown in FIG. 5, in some aspects, process 500 may include receiving, via a user interface of the UE, an indication of a mobility mode associated with the UE, wherein the mobility mode indicates an environment associated with the UE (block 510). For example, the UE (e.g., using communication manager 140 and/or interface component 608, depicted in FIG. 6) may receive, via a user interface of the UE, an indication of a mobility mode associated with the UE, wherein the mobility mode indicates an environment associated with the UE, as described above.

As further shown in FIG. 5, in some aspects, process 500 may include performing an action based at least in part on the mobility mode associated with the UE (block 520). For example, the UE (e.g., using communication manager 140 and/or action component 610, depicted in FIG. 6) may perform an action based at least in part on the mobility mode associated with the UE, as described above.

Process 500 may include additional aspects, such as any single aspect or any combination of aspects described below and/or in connection with one or more other processes described elsewhere herein.

In a first aspect, the mobility mode indicating the environment associated with the UE is a high speed train mode associated with the UE traveling on a high speed train or a subway mode associated with the UE traveling on a subway. In a second aspect, alone or in combination with the first aspect, the mobility mode indicating the environment associated with the UE is a passenger vehicle mode including one of a freeway mode associated with the UE traveling on a freeway, a city mode associated with the UE traveling in a city, a rural mode associated with the UE traveling in a rural area, or a water body mode associated with the UE traveling on a body of water.

In a third aspect, alone or in combination with one or more of the first and second aspects, the mobility mode indicating the environment associated with the UE is a vehicle operation mode indicating whether the UE is being operated by an occupant of a vehicle, and wherein one or more capabilities of the UE are locked based at least in part on the vehicle operation mode. In a fourth aspect, alone or in combination with one or more of the first through third aspects, the mobility mode indicating the environment associated with the UE is a power conservation mode associated with limited services for the UE to reduce a power consumption of the UE.

In a fifth aspect, alone or in combination with one or more of the first through fourth aspects, process 500 includes disabling or enabling one or more features of the UE based at least in part on the mobility mode associated with the UE, as described in connection to FIG. 3. In a sixth aspect, alone or in combination with one or more of the first through fifth aspects, process 500 includes overriding a network control based at least in part on the mobility mode associated with the UE, as described in connection to FIG. 3. In a seventh aspect, alone or in combination with one or more of the first through sixth aspects, process 500 includes performing a cell search operation and cell measurements based at least in part on the mobility mode associated with the UE, as described in connection to FIG. 3.

In an eighth aspect, alone or in combination with one or more of the first through seventh aspects, process 500 includes performing a channel estimation based at least in part on the mobility mode associated with the UE, as described in connection to FIG. 3. In a ninth aspect, alone or in combination with one or more of the first through eighth aspects, process 500 includes performing an antenna control based at least in part on the mobility mode associated with the UE, as described in connection to FIG. 3. In a tenth aspect, alone or in combination with one or more of the first through ninth aspects, process 500 includes performing a sleep operation or a wakeup operation based at least in part on the mobility mode associated with the UE, as described in connection to FIG. 3.

In an eleventh aspect, alone or in combination with one or more of the first through tenth aspects, process 500 includes activating or deactivation a processing block based at least in part on the mobility mode associated with the UE, as described in connection to FIG. 3. In a twelfth aspect, alone or in combination with one or more of the first through eleventh aspects, process 500 includes performing the action irrespective of a high speed configuration received from a base station, as described in connection to FIG. 3. In a thirteenth aspect, alone or in combination with one or more of the first through twelfth aspects, process 500 includes performing a handover based at least in part on the mobility mode associated with the UE, as described in connection to FIG. 3.

In a fourteenth aspect, alone or in combination with one or more of the first through thirteenth aspects, process 500 includes applying safety features based at least in part on the mobility mode associated with the UE, as described in connection to FIG. 3. In a fifteenth aspect, alone or in combination with one or more of the first through fourteenth aspects, process 500 includes providing the user interface that displays a plurality of possible mobility modes, as described in connection to FIG. 3. In a sixteenth aspect, alone or in combination with one or more of the first through fifteenth aspects, process 500 includes determining the mobility mode for the UE based at least in part on signal measurements, and providing, via the user interface, a recommendation to switch to the mobility mode, as described in connection to FIG. 3. In a seventeenth aspect, alone or in combination with one or more of the first through sixteenth aspects, the user interface provides one or more of a touch interface or a voice command interface.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 140. The communication manager 140 may include one or more of an interface component 608, or an action component 610, among other examples.

In some aspects, the apparatus 600 may be configured to perform one or more operations described herein in connection with FIGS. 3-4. Additionally, or alternatively, the apparatus 600 may be configured to perform one or more processes described herein, such as process 500 of FIG. 5. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 600. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

The interface component 608 may receive, via a user interface of the UE, an indication of a mobility mode associated with the UE, wherein the mobility mode indicates an environment associated with the UE. The action component 610 may perform an action based at least in part on the mobility mode associated with the UE.

The action component 610 may disable or enable one or more features of the UE based at least in part on the mobility mode associated with the UE. The action component 610 may override a network control based at least in part on the mobility mode associated with the UE. The action component 610 may perform a cell search operation and cell measurements based at least in part on the mobility mode associated with the UE, wherein the cell search operation is based at least in part on a property of a cell associated with the mobility mode. The action component 610 may perform a channel estimation based at least in part on the mobility mode associated with the UE. The action component 610 may perform an antenna control based at least in part on the mobility mode associated with the UE. The action component 610 may perform a sleep operation or a wakeup operation based at least in part on the mobility mode associated with the UE. The action component 610 may activate or deactivate a processing block based at least in part on the mobility mode associated with the UE. The action component 610 may perform the action irrespective of a high speed configuration received from a base station. The action component 610 may perform a handover based at least in part on the mobility mode associated with the UE. The action component 610 may apply safety features based at least in part on the mobility mode associated with the UE.

The interface component 608 may provide the user interface that displays a plurality of possible mobility modes. The interface component 608 may determine the mobility mode for the UE based at least in part on signal measurements. The interface component 608 may provide, via the user interface, a recommendation to switch to the mobility mode.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

The following provides an overview of some Aspects of the present disclosure:

Aspect 1: A method of wireless communication performed by a user

equipment (UE), comprising: receiving, via a user interface of the UE, an indication of a mobility mode associated with the UE, wherein the mobility mode indicates an environment associated with the UE; and performing an action based at least in part on the mobility mode associated with the UE.

Aspect 2: The method of Aspect 1, wherein the mobility mode indicating the environment associated with the UE is a high speed train mode associated with the UE traveling on a high speed train or a subway mode associated with the UE traveling on a subway.

Aspect 3: The method of any of Aspects 1 through 2, wherein the mobility mode indicating the environment associated with the UE is a passenger vehicle mode including one of: a freeway mode associated with the UE traveling on a freeway, a city mode associated with the UE traveling in a city, a rural mode associated with the UE traveling in a rural area, or a water body mode associated with the UE traveling on a body of water.

Aspect 4: The method of any of Aspects 1 through 3, wherein the mobility mode indicating the environment associated with the UE is a vehicle operation mode indicating whether the UE is being operated by an occupant of a vehicle, and wherein one or more capabilities of the UE are locked based at least in part on the vehicle operation mode.

Aspect 5: The method of any of Aspects 1 through 4, wherein the mobility mode indicating the environment associated with the UE is a power conservation mode associated with limited services for the UE to reduce a power consumption of the UE.

Aspect 6: The method of any of Aspects 1 through 5, wherein performing the action comprises disabling or enabling one or more features of the UE based at least in part on the mobility mode associated with the UE.

Aspect 7: The method of any of Aspects 1 through 6, wherein performing the action comprises overriding a network control based at least in part on the mobility mode associated with the UE.

Aspect 8: The method of any of Aspects 1 through 7, wherein performing the action comprises performing a cell search operation and cell measurements based at least in part on the mobility mode associated with the UE, wherein the cell search operation is based at least in part on a property of a cell associated with the mobility mode.

Aspect 9: The method of any of Aspects 1 through 8, wherein performing the action comprises performing a channel estimation based at least in part on the mobility mode associated with the UE.

Aspect 10: The method of any of Aspects 1 through 9, wherein performing the action comprises performing an antenna control based at least in part on the mobility mode associated with the UE.

Aspect 11: The method of any of Aspects 1 through 10, wherein performing the action comprises performing a sleep operation or a wakeup operation based at least in part on the mobility mode associated with the UE.

Aspect 12: The method of any of Aspects 1 through 11, wherein performing the action comprises activating or deactivation a processing block based at least in part on the mobility mode associated with the UE.

Aspect 13: The method of any of Aspects 1 through 12, wherein performing the action comprises performing the action irrespective of a high speed configuration received from a base station.

Aspect 14: The method of any of Aspects 1 through 13, wherein performing the action comprises performing a handover based at least in part on the mobility mode associated with the UE.

Aspect 15: The method of any of Aspects 1 through 14, wherein performing the action comprises applying safety features based at least in part on the mobility mode associated with the UE.

Aspect 16: The method of any of Aspects 1 through 15, further comprising: providing the user interface that displays a plurality of possible mobility modes.

Aspect 17: The method of any of Aspects 1 through 16, further comprising: determining the mobility mode for the UE based at least in part on signal measurements; and providing, via the user interface, a recommendation to switch to the mobility mode.

Aspect 18: The method of any of Aspects 1 through 17, wherein the user interface provides one or more of a touch interface or a voice command interface.

Aspect 19: An apparatus for wireless communication at a device, comprising a processor; memory coupled with the processor; and instructions stored in the memory and executable by the processor to cause the apparatus to perform the method of one or more of Aspects 1-18.

Aspect 20: A device for wireless communication, comprising a memory and one or more processors coupled to the memory, the one or more processors configured to perform the method of one or more of Aspects 1-18.

Aspect 21: An apparatus for wireless communication, comprising at least one means for performing the method of one or more of Aspects 1-18.

Aspect 22: A non-transitory computer-readable medium storing code for wireless communication, the code comprising instructions executable by a processor to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, via a user interface of the UE, an indication of a mobility mode associated with the UE, wherein the mobility mode indicates an environment associated with the UE; and
perform an action based at least in part on the mobility mode associated with the UE.

2. The apparatus of claim 1, wherein the mobility mode indicating the environment associated with the UE is a high speed train mode associated with the UE traveling on a high speed train or a subway mode associated with the UE traveling on a subway.

3. The apparatus of claim 1, wherein the mobility mode indicating the environment associated with the UE is a passenger vehicle mode including one of: a freeway mode associated with the UE traveling on a freeway, a city mode associated with the UE traveling in a city, a rural mode associated with the UE traveling in a rural area, or a water body mode associated with the UE traveling on a body of water.

4. The apparatus of claim 1, wherein the mobility mode indicating the environment associated with the UE is a vehicle operation mode indicating whether the UE is being operated by an occupant of a vehicle, and wherein one or more capabilities of the UE are locked based at least in part on the vehicle operation mode.

5. The apparatus of claim 1, wherein the mobility mode indicating the environment associated with the UE is a power conservation mode associated with limited services for the UE to reduce a power consumption of the UE.

6. The apparatus of claim 1, wherein the one or more processors, to perform the action, are configured to disable or enable one or more features of the UE based at least in part on the mobility mode associated with the UE.

7. The apparatus of claim 1, wherein the one or more processors, to perform the action, are configured to override a network control based at least in part on the mobility mode associated with the UE.

8. The apparatus of claim 1, wherein the one or more processors, to perform the action, are configured to perform a cell search operation and cell measurements based at least in part on the mobility mode associated with the UE, wherein the cell search operation is based at least in part on a property of a cell associated with the mobility mode.

9. The apparatus of claim 1, wherein the one or more processors, to perform the action, are configured to perform a channel estimation based at least in part on the mobility mode associated with the UE.

10. The apparatus of claim 1, wherein the one or more processors, to perform the action, are configured to perform an antenna control based at least in part on the mobility mode associated with the UE.

11. The apparatus of claim 1, wherein the one or more processors, to perform the action, are configured to perform a sleep operation or a wakeup operation based at least in part on the mobility mode associated with the UE.

12. The apparatus of claim 1, wherein the one or more processors, to perform the action, are configured to activate or deactivate a processing block based at least in part on the mobility mode associated with the UE.

13. The apparatus of claim 1, wherein the one or more processors, to perform the action, are configured to perform the action irrespective of a high speed configuration received from a base station.

14. The apparatus of claim 1, wherein the one or more processors, to perform the action, are configured to perform a handover based at least in part on the mobility mode associated with the UE.

15. The apparatus of claim 1, wherein the one or more processors, to perform the action, are configured to apply safety features based at least in part on the mobility mode associated with the UE.

16. The apparatus of claim 1, wherein the one or more processors are further configured to:
provide the user interface that displays a plurality of possible mobility modes.

17. The apparatus of claim 1, wherein the one or more processors are further configured to:
determine the mobility mode for the UE based at least in part on signal measurements; and
provide, via the user interface, a recommendation to switch to the mobility mode.

18. The apparatus of claim 1, wherein the user interface provides one or more of a touch interface or a voice command interface.

19. A method of wireless communication performed by a user equipment (UE), comprising:
receiving, via a user interface of the UE, an indication of a mobility mode associated with the UE, wherein the mobility mode indicates an environment associated with the UE; and
performing an action based at least in part on the mobility mode associated with the UE.

20. The method of claim 19, wherein the mobility mode indicating the environment associated with the UE is a high speed train mode associated with the UE traveling on a high speed train or a subway mode associated with the UE traveling on a subway.

21. The method of claim 19, wherein the mobility mode indicating the environment associated with the UE is a passenger vehicle mode including one of: a freeway mode associated with the UE traveling on a freeway, a city mode associated with the UE traveling in a city, a rural mode associated with the UE traveling in a rural area, or a water body mode associated with the UE traveling on a body of water.

22. The method of claim 19, wherein the mobility mode indicating the environment associated with the UE is a vehicle operation mode indicating whether the UE is being operated by an occupant of a vehicle, and wherein one or more capabilities of the UE are locked based at least in part on the vehicle operation mode.

23. The method of claim 19, wherein the mobility mode indicating the environment associated with the UE is a power conservation mode associated with limited services for the UE to reduce a power consumption of the UE.

24. The method of claim 19, wherein performing the action comprises:
disabling or enabling one or more features of the UE based at least in part on the mobility mode associated with the UE; or
overriding a network control based at least in part on the mobility mode associated with the UE.

25. The method of claim 19, wherein performing the action comprises:
performing a cell search operation and cell measurements based at least in part on the mobility mode associated with the UE, wherein the cell search operation is based at least in part on a property of a cell associated with the mobility mode; or
performing a channel estimation based at least in part on the mobility mode associated with the UE.

26. The method of claim 19, wherein performing the action comprises:
performing an antenna control based at least in part on the mobility mode associated with the UE; or
performing a sleep operation or a wakeup operation based at least in part on the mobility mode associated with the UE.

27. The method of claim 19, wherein performing the action comprises:
activating or deactivation a processing block based at least in part on the mobility mode associated with the UE; or
performing the action irrespective of a high speed configuration received from a base station.

28. The method of claim 19, wherein performing the action comprises:
performing a handover based at least in part on the mobility mode associated with the UE; or
performing the action comprises applying safety features based at least in part on the mobility mode associated with the UE.

29. A non-transitory computer-readable medium storing a set of instructions for wireless communication, the set of instructions comprising:
one or more instructions that, when executed by one or more processors of a user equipment (UE), cause the UE to:
receive, via a user interface of the UE, an indication of a mobility mode associated with the UE, wherein the mobility mode indicates an environment associated with the UE; and
perform an action based at least in part on the mobility mode associated with the UE.

30. An apparatus for wireless communication, comprising:
means for receiving, via a user interface of the apparatus, an indication of a mobility mode associated with the apparatus, wherein the mobility mode indicates an environment associated with the apparatus; and
means for performing an action based at least in part on the mobility mode associated with the apparatus.
